(19) United States
(12) Patent Application Publication
(10) Pub. No.: US 2014/0213446 A1
(43) Pub. Date: Jul. 31, 2014

(54) HERBICIDAL COMPOSITIONS AND METHODS USING COMBINATIONS OF 4-AMINO-3-CHLORO-6-(4-CHLORO-2-FLUORO-3-METHOXYPHENYL)PYRIDINE-2-CARBOXYLIC ACID OR A DERIVATIVE THEREOF AND AN ARYLOXYPHENOXY PROPIONATE ACCASE INHIBITOR HERBICIDE

(71) Applicants: Carla N. Yerkes, Crawfordsville, IN (US); Norbert M. Satchivi, Carmel, IN (US); Bryston L. Bangel, Camby, IN (US)

(72) Inventors: Carla N. Yerkes, Crawfordsville, IN (US); Norbert M. Satchivi, Carmel, IN (US); Bryston L. Bangel, Camby, IN (US)

(73) Assignee: DOW AGROSCIENCES LLC, Indianapolis, IN (US)

(21) Appl. No.: 14/162,994

(22) Filed: Jan. 24, 2014

Related U.S. Application Data
(60) Provisional application No. 61/756,930, filed on Jan. 25, 2013.

(51) Int. Cl. A01N 43/40; A01N 43/60

(52) U.S. Cl. CPC A01N 43/40; A01N 43/60
USPC 504/103; 504/130; 504/136

(57) ABSTRACT

Herbicidal compositions and methods using a combination of (a) a compound of formula (I):

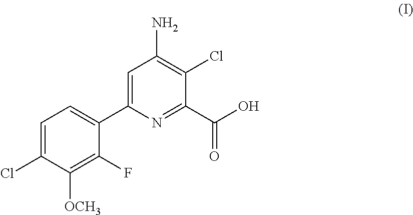 [SMILES: COc1c(Cl)ccc(-c2cc(N)c(Cl)c(C(=O)O)n2)c1F]

or an agriculturally acceptable salt or ester thereof and (b) an aryloxyphenoxy propionate ACCase inhibitor herbicide selected from the group consisting of fluazifop-P, haloxyfop-P, and quizalofop-P or an agriculturally acceptable salt or ester thereof provide control of undesirable vegetation in, e.g., rice, wheat, barley, triticale, oats, rye, sorghum, corn or maize, oilseed rape, vegetables, pastures, grasslands, rangelands, fallowland, turf, tree and vine orchards, aquatics, industrial vegetation management (IVM) or rights-of-way.

### CROSS REFERENCE TO RELATED APPLICATIONS

This application claims the benefit of U.S. Provisional Patent Application Ser. No. 61/756,930 filed Jan. 25, 2013, the disclosure of which is expressly incorporated herein by reference.

### BACKGROUND

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. However, there remains a need for compositions and methods that are effective in controlling undesirable vegetation.

US2011/0287933 A1 describes three component herbicidal combinations for controlling harmful plants in oilseed rape crops, wherein the first component is glufosinate, L-glufosinate, or bialaphos or a derivative thereof, the second component is, e.g., 4-amino-3-chloro-6-(4-chloro-2-fluoro-3-methoxyphenyl)-pyridine-2-carboxylic acid or an ester thereof, and the third component can be, e.g., haloxyfop-P, fluazifop-P-butyl, haloxyfop-P-methyl, quizalofop-P, or quizalofop-P-ethyl.

### SUMMARY

Provided herein are herbicidal compositions comprising an herbicidally effective amount of (a) a compound of the formula (I)

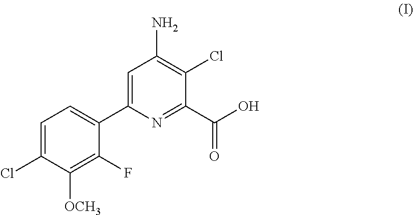 [SMILES: COc1c(Cl)ccc(-c2cc(N)c(Cl)c(C(=O)O)n2)c1F]

or an agriculturally acceptable salt or ester of thereof, and (b) an aryloxyphenoxy propionate ACCase inhibitor herbicide selected from the group consisting of fluazifop-P, haloxyfop-P, and quizalofop-P or an agriculturally acceptable salt or ester thereof. The compositions may also contain an agriculturally acceptable adjuvant or carrier.

Also provided are methods of controlling undesired vegetation comprising applying (a) a compound of formula (I) or an agriculturally acceptable ester or salt thereof and (b) an aryloxyphenoxy propionate ACCase inhibitor herbicide selected from the group consisting of fluazifop-P, haloxyfop-P, and quizalofop-P or an agriculturally acceptable salt or ester thereof.

### DETAILED DESCRIPTION

### Definitions

As used herein, the compound of formula (I) has the following structure:

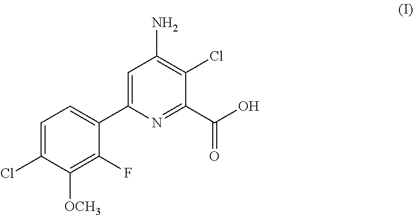 [SMILES: COc1c(Cl)ccc(-c2cc(N)c(Cl)c(C(=O)O)n2)c1F]

The compound of formula (I) can be identified by the name 4-amino-3-chloro-6-(4-chloro-2-fluoro-3-methoxyphenyl)-pyridine-2-carboxylic acid and has been described in U.S. Pat. No. 7,314,849 (B2), which is incorporated herein by reference in its entirety. Exemplary uses of the compound of the formula (I) include controlling undesirable vegetation, including e.g., grass, broadleaf and sedge weeds, in multiple non-crop and cropping situations.

As used herein, fluazifop-P is (R)-2-[4-[[5-(trifluoromethyl)-2-pyridinyl]oxy]phenoxy]propanoic acid. Its herbicidal activity is summarized in Tomlin, C. D. S., Ed. The Pesticide Manual: A World Compendium, 15^{th} ed.; BCPC: Alton, 2009 (hereafter “The Pesticide Manual”). The butyl ester of fluazifop-P is specifically identified in The Pesticide Manual. Exemplary uses of fluazifop-P-butyl identified in The Pesticide Manual include post-emergence control of wild oats, volunteer cereals, and annual and perennial grass weeds in oilseed rape, sugar beet, fodder beet, potatoes, vegetables, cotton, soya beans, various fruits, sunflowers, alfalfa, ornamentals, and other broad-leaved crops.

As used herein, haloxyfop-P is (R)-2-[4-[[3-chloro-5-(trifluoromethyl)-2-pyridinyl]oxy]phenoxy]propanoic acid. Its herbicidal activity is summarized in The Pesticide Manual. The methyl ester of haloxyfop-P is specifically identified in The Pesticide Manual. Exemplary uses of haloxyfop-P-methyl identified in The Pesticide Manual include post-emergence control of annual and perennial grasses in oilseed rape, sugar beet, fodder beet, potatoes, leaf vegetables, onions, flax, cotton, soya beans, sunflowers, vines, and strawberries.

As used herein, quizalofop-P is (R)-2-[4-[(6-chloro-2-quinoxalinyl)oxy]phenoxy]propanoic acid. Its herbicidal activity is summarized in The Pesticide Manual. The ethyl and tetrahydrofurfuryl esters of quizalofop-P are specifically identified in The Pesticide Manual. Exemplary uses of the ethyl ester identified in The Pesticide Manual include selective post-emergence control of annual and perennial weeds in potatoes, soya beans, sugar beet, peanuts, oilseed rape, sunflowers, vegetables, cotton, and flax. Exemplary uses of the tetrahydrofurfuryl identified in The Pesticide Manual include control of annual grasses and perennial grasses in oilseed rape, sugar beet, fodder beet, potatoes, linseed, sunflowers, peas, field beans and other pulse crops.

As used herein, propargyl refers to the 2-propynyl group: HC≡C≡CH₂—.

As used herein, control of or controlling undesirable vegetation means killing or preventing the vegetation, or causing some other adversely modifying effect to the vegetation, such as deviations from natural growth or development, regulation, desiccation, retardation, and the like.

As used herein, herbicide and herbicidal active ingredient mean a compound that controls undesirable vegetation when applied in an appropriate amount.

As used herein, a herbicidally effective or vegetation controlling amount is an amount of herbicidal active ingredient the application of which controls the relevant undesirable vegetation.

As used herein, applying a herbicide or herbicidal composition means delivering it directly to the targeted vegetation or to the locus thereof or to the area where control of undesired vegetation is desired. Methods of application include, but are not limited to preemergence, postemergence, foliar, soil, and in-water applications. Described herein are methods of controlling undesirable vegetation by applying certain herbicide combinations or compositions.

As used herein, plants and vegetation include, but are not limited to, dormant seeds, germinant seeds, emerging seedlings, plants emerging from vegetative propagules, immature vegetation, and established vegetation.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can by hydrolyzed, oxidized, metabolized, or otherwise converted, e.g., in plants, water, or soil, to the corresponding carboxylic acid which, depending on the pH, may be in the dissociated or undissociated form.

Exemplary salts include those derived from alkali or alkaline earth metals and those derived from ammonia and amines. Exemplary cations include sodium, potassium, magnesium, and aminium cations of the formula:

R¹R²R³R⁴N⁺

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment with a metal hydroxide, such as sodium hydroxide, with an amine, such as ammonia, trimethylamine, diethanolamine, 2-methylthiopropylamine, bisallylamine, 2-butoxyethylamine, morpholine, cyclododecylamine, or benzylamine or with a tetraalkylammonium hydroxide, such as tetramethylammonium hydroxide or choline hydroxide.

Exemplary esters include those derived from C₁-C₁₂ alkyl, C₃-C₁₂ alkenyl, C₃-C₁₂ alkynyl or C₇-C₁₀ aryl-substituted alkyl alcohols, such as methyl alcohol, isopropyl alcohol, 1-butanol, 2-ethylhexanol, butoxyethanol, methoxypropanol, allyl alcohol, propargyl alcohol, cyclohexanol or unsubstituted or substituted benzyl alcohols. Benzyl alcohols may be substituted with from 1-3 substituents independently selected from halogen, C₁-C₄ alkyl or C₁-C₄ alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

As used herein, weight ratios of mixtures are calculated using the acid equivalent weight(s) of any compounds in the mixture that are salts or esters.

Compositions and Methods

Provided herein are herbicidal compositions comprising an herbicidally effective amount of (a) a compound of the formula (I)

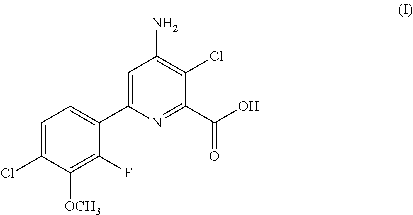 [SMILES: COc1c(Cl)ccc(-c2cc(N)c(Cl)c(C(=O)O)n2)c1F]

or an agriculturally acceptable salt or ester of thereof, and (b) an aryloxyphenoxy propionate ACCase inhibitor herbicide selected from the group consisting of fluazifop-P, haloxyfop-P, and quizalofop-P or an agriculturally acceptable salt or ester thereof, provided that the composition does not contain glufosinate or its salts, L-glufosinate or its salts, or bialaphos or its salts.

Also provided are methods of controlling undesirable vegetation comprising contacting the vegetation or the locus thereof, i.e., the area adjacent to the plant, with or applying to the soil or water to prevent the emergence or growth of vegetation an herbicidally effective amount of the compound of formula (I) or an agriculturally acceptable salt or ester thereof (b) an aryloxyphenoxy propionate ACCase inhibitor herbicide selected from the group consisting of fluazifop-P, haloxyfop-P, and quizalofop-P or an agriculturally acceptable salt or ester thereof. In certain embodiments, the methods employ the compositions described herein.

Furthermore, in some embodiments, the combination of compound (I) or agriculturally acceptable salt or ester thereof and (b) an aryloxyphenoxy propionate ACCase inhibitor herbicide selected from the group consisting of fluazifop-P, haloxyfop-P, and quizalofop-P or an agriculturally acceptable salt or ester thereof exhibits synergism, e.g., the herbicidal active ingredients are more effective in combination than when applied individually. Synergism has been defined as “an interaction of two or more factors such that the effect when combined is greater than the predicted effect based on the response of each factor applied separately.” Senseman, S., Ed. Herbicide Handbook. 9^{th} ed. Lawrence: Weed Science Society of America, 2007. In certain embodiments, the compositions exhibit synergy as determined by the Colby's equation. Colby, S. R. Calculation of the synergistic and antagonistic response of herbicide combinations. Weeds 1967, 15, 20-22.

In certain embodiments of the compositions and methods described herein, the carboxylic acid of formula (I) is employed. In certain embodiments, a carboxylate salt of the compound of formula (I) is employed. In certain embodiments, a C₁-C₄ alkyl ester, e.g., methyl ester, is employed. In certain embodiments, a C₇-C₁₀ aryl-substituted alkyl ester, e.g., unsubstituted benzyl ester, is employed. In certain embodiments, a C₃-C₁₂ alkynyl ester, e.g., propargyl ester, is employed.

In some embodiments, the compound of formula (I) or salt or ester thereof and (b) an aryloxyphenoxy propionate ACCase inhibitor herbicide selected from the group consisting of fluazifop-P, haloxyfop-P, and quizalofop-P or an agriculturally acceptable salt or ester thereof are formulated in one composition, tank-mixed, applied simultaneously, or applied sequentially.

Herbicidal activity (control of undesirable vegetation) is exhibited by the compositions when they are applied directly to the plant or to the locus of, i.e., area adjacent to the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. In some embodiments, the compositions described herein are applied as a post-emergence application, pre-emergence application, or in-water application to flooded paddy rice or water bodies (e.g., ponds, lakes and streams), to relatively immature undesirable vegetation to achieve the maximum control of weeds.

In some embodiments, the compositions and methods provided herein are utilized to control weeds in crops, including but not limited to winter/spring oilseed rape, winter/spring canola, vegetables, Brassica spp, ornamentals, rice, wheat, triticale, barley, oats, rye, sorghum, corn/maize, sunflower, row crops, pastures, grasslands, rangelands, fallowland, sugarcane, turf, tree and vine orchards, aquatics, and industrial vegetation management and rights-of-way.

The compositions and methods provided herein are utilized to control undesirable vegetation. Undesirable vegetation includes, but is not limited to, undesirable vegetation that occurs in oilseed rape, canola, vegetables, Brassica spp., ornamentals, rice, wheat, triticale, barley, oats, rye, sorghum, corn/maize, sunflower, row crops, pastures, grasslands, rangelands, fallowland, sugarcane, turf, tree and vine orchards, aquatics, and industrial vegetation management (IVM) and rights-of-way.

In some embodiments, the methods provided herein are utilized to control undesirable vegetation in oilseed rape, canola, drilled crops and cereal crops. In certain embodiments, the undesirable vegetation is Alopecurus myosuroides Huds. (blackgrass, ALOMY), Apera spica-venti (L.) Beauv. (windgrass, APESV), Avena fatua L. (wild oat, AVEFA), Bromus tectorum L. (downy brome, BROTE), Lolium multiflorum Lam. (Italian ryegrass, LOLMU), Lolium rigidum (rigid ryegrass, LOLRI), Lolium multiflorum subsp. Gaudini (annual ryegrass, LOLMG), Phalaris minor Retz. (littleseed canarygrass, PHAMI), Poa annua L. (annual bluegrass, POAAN), Setaria pumila (Poir.) Roemer & J. A. Schultes (yellow foxtail, SETLU), Setaria viridis (L.) Beauv. (green foxtail, SETVI), Cirsium arvense (L.) Scop. (Canada thistle, CIRAR), Galium aparine L. (catchweed bedstraw, GALAP), Kochia scoparia (L.) Schrad. (kochia, KCHSC), Lamium purpureum L. (purple deadnettle, LAMPU), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR).

In some embodiments, the compositions and methods provided herein are utilized to control undesirable vegetation in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (Fall panicum, PANDI), Paspalum dilatatum Poir. (dallisgrass, PASDI), Cyperus difformis L. (smallflower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SPCJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Burnt F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (mild smartweed, POLHP), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In some embodiments, the compositions and methods provided herein are utilized to control undesirable vegetation in range and pasture. In certain embodiments, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G. H. Weber ex Wiggers (dandelion, TAROF), Trifolium repens L. (white clover, TRFRE), or Urtica dioica L. (common nettle, URTDI).

In some embodiments, the compositions and methods provided herein are utilized to control undesirable vegetation found in row crops and vegetable crops. In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (Fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (Western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Erigeron bonariensis L. (hairy fleabane, ERIBO), Erigeron canadensis L. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), or Xanthium strumarium L. (common cocklebur, XANST).

In some embodiments, the compositions and methods provided herein are utilized to control undesirable vegetation consisting of grass, broadleaf and sedge weeds.

In some embodiments, the compositions and methods provided herein are used to control Amaranthus retroflexus (redroot pigweed, AMARE), Chenopodium album (common lambsquarters, CHEAL), Centaurea cyanus (cornflower, CENCY), Descurainia sophia (flixweed, DESSO), Conyza canadensis (horseweed/marestail, ERICA), Conyza bonariensis (fleabane, ERIBO), Erodium cicutarium (storksbill/redstem filaree, EROCI), Fumaria officinalis (common fumitory, FUMOF), Galeopsis tetrahit (common hempnettle, GAETE), Galium aparine (bedstraw, catchweed/cleavers, GALAP), Geranium dissectum (cutleaf geranium, GERDI), Geranium pusillum (smallflower geranium, GERPU), Glycine max (volunteer soybean, GLXMA), Lamium amplexicaule (henbit, LAMAM), Lamium purpuruem (purple deadnettle, LAMPU), Papaver rhoeas (common poppy, PAPRH), Stellaria media (common chickweed, STEME), Veronica persica (Persian speedwell, VERPE), Linum usitatissimum (volunteer flax, LIUUT), Geranium carolinianum (Carolina Geranium, GERCA), or Vicia villosa (hairy vetch, VICVI).

In certain embodiments, the compositions and methods provided herein are used to provide synergistic control of BRSNW, CHEAL, VIOTR, STEME, AVEFA, DIGSA, ABUTH, CIRAR, SETFA, SORVU, AMARE, EPHHL, CYPES, IPOHE, GLXMA, HELAN, OEOBI, LOLMU, or SORHA.

In certain embodiments of the compositions and methods described herein, the combination of herbicidally active ingredients is comprised of (a) the compound of formula (I) or agriculturally acceptable salt or ester thereof and (b) fluazifop-P or an agriculturally acceptable salt or ester thereof, and the two components are used in amounts such that the weight ratio of (a) to (b) is from about 1-40 of (a) to about 35-560 of (b). In certain embodiments the weight ratio of these components is from about 1-40 of (a) to about 70-210 of (b). In certain embodiments the weight ratio of these components is from about 1.25-5 of (a) to about 70-210 of (b). In certain embodiments, the weight ratio of (a) the compound of formula (I) or salt or ester thereof to (b) fluazifop-P or an agriculturally acceptable salt or ester thereof is from about 1:560 to about 1:1. In one embodiment, the composition comprises (a) the methyl ester of the compound of formula (I) and (b) fluazifop-P or an agriculturally acceptable salt or ester thereof, wherein the weight ratio of the two components is from about 1.25-5 of (a) to about 70-210 of (b). In one embodiment, the combination comprises (a) the methyl ester of the compound of formula (I) and (b) fluazifop-P or an agriculturally acceptable salt or ester thereof wherein the weight ratio is 1:170 to 1:10.

In some embodiments, the method comprises applying the compound of formula (I) or salt or ester thereof at a rate of 1-40 grams acid equivalent per hectare (g ae/ha) and applying fluazifop-P or an agriculturally acceptable salt or ester thereof at a rate of 35-560 g ae/ha. In some embodiments, the method comprises applying the compound of formula (I) or salt or ester thereof at a rate of 1-40 g ae/ha and applying fluazifop-P or an agriculturally acceptable salt or ester thereof at a rate of 70-210 g ae/ha. In some embodiments, the method comprises applying the compound of formula (I) or salt or ester thereof at a rate of 1.25-5 g ae/ha and applying fluazifop-P or an agriculturally acceptable salt or ester thereof at a rate of 70-210 g ae/ha.

In certain embodiments of the compositions and methods described herein, the combination of herbicidally active ingredients is comprised of (a) the compound of formula (I) or agriculturally acceptable salt or ester thereof and (b) haloxyfop-P or an agriculturally acceptable salt or ester thereof, and the two components are used in amounts such that the weight ratio of (a) to (b) is from about 1-40 of (a) to about 20-560 of (b). In certain embodiments the weight ratio of these components is from about 1-40 of (a) to about 35-150 of (b). In certain embodiments the weight ratio of these components is from about 1.25-5 of (a) to about 35-150 of (b). In certain embodiments, the weight ratio of (a) the compound of formula (I) or salt or ester thereof to (b) haloxyfop-P or an agriculturally acceptable salt or ester thereof is from about 1:560 to about 1:1. In one embodiment, the composition comprises (a) the methyl ester of the compound of formula (I) and (b) haloxyfop-P or an agriculturally acceptable salt or ester thereof, wherein the weight ratio of the two components is from about 1.25-5 of (a) to about 35-150 of (b). In one embodiment, the combination comprises (a) the methyl ester of the compound of formula (I) and (b) haloxyfop-P or an agriculturally acceptable salt or ester thereof wherein the weight ratio is 1:120 to 1:7.

In some embodiments, the method comprises applying the compound of formula (I) or salt or ester thereof at a rate of 1-40 g ae/ha and applying haloxyfop-P or an agriculturally acceptable salt or ester thereof at a rate of 20-560 g ae/ha. In some embodiments, the method comprises applying the compound of formula (I) or salt or ester thereof at a rate of 1-40 g ae/ha and applying haloxyfop-P or an agriculturally acceptable salt or ester thereof at a rate of 35-150 g ae/ha. In some embodiments, the method comprises applying the compound of formula (I) or salt or ester thereof at a rate of 1.25-5 g ae/ha and applying haloxyfop-P or an agriculturally acceptable salt or ester thereof at a rate of 35-150 g ae/ha.

In certain embodiments of the compositions and methods described herein, the combination of herbicidally active ingredients is comprised of (a) the compound of formula (I) or agriculturally acceptable salt or ester thereof and (b) quizalofop-P or an agriculturally acceptable salt or ester thereof, and the two components are used in amounts such that the application rate of (a) and (b) is from about 1-40 g ae/ha of (a) to about 3.5-560 g ae/ha of (b). In certain embodiments the weight ratio of these components is from about 1-40 of (a) to about 3.5-150 of (b). In certain embodiments the weight ratio of these components is from about 1.25-15 of (a) to about 3.5-150 of (b). In certain embodiments, the weight ratio of (a) the compound of formula (I) or salt or ester thereof to (b) quizalofop-P or an agriculturally acceptable salt or ester thereof is from about 1:560 to about 11.2:1. In one embodiment, the composition comprises (a) the methyl ester, benzyl ester, propargyl ester, or potassium salt of the compound of formula (I) and (b) quizalofop-P or an agriculturally acceptable salt or ester thereof, wherein the weight ratio of the two components is from about 1.25-15 of (a) to about 3.5-150 of (b). In one embodiment, the combination comprises (a) the methyl ester, benzyl ester, propargyl ester, or potassium salt of the compound of formula (I) and (b) quizalofop-P or an agriculturally acceptable salt or ester thereof wherein the weight ratio is 1:120 to 4.2:1.

In some embodiments, the method comprises applying the compound of formula (I) or salt or ester thereof at a rate of 1-40 g ae/ha and applying quizalofop-P or an agriculturally acceptable salt or ester thereof at a rate of 3.5-560 g ae/ha. In some embodiments, the method comprises applying the compound of formula (I) or salt or ester thereof at a rate of 1-40 g ae/ha and applying quizalofop-P or an agriculturally acceptable salt or ester thereof at a rate of 3.5-150 g ae/ha. In some embodiments, the method comprises applying the compound of formula (I) or salt or ester thereof at a rate of 1.25-15 g ae/ha and applying quizalofop-P or an agriculturally acceptable salt or ester thereof at a rate of 3.5-150 g ae/ha.

In certain embodiments, the methods comprise contacting the undesirable vegetation or locus thereof with the herbicidally active components or applying the components to the soil or water to prevent the emergence or growth of vegetation a composition described herein. In some embodiments, the composition is applied at an application rate from about 5 grams active ingredient per hectare (g ai/ha) to about 600 g ai/ha based on the total amount of herbicidal active ingredients in the composition. In certain embodiments, the composition is applied at an application rate from about 20 g ai/ha to about 220 g ai/ha based on the total amount of active ingredients in the composition. In some embodiments, the composition is applied at an application rate from about 4.5 grams acid equivalent per hectare (g ae/ha) to about 600 g ae/ha based on the total amount of herbicidal active ingredients in the composition. In certain embodiments, the composition is applied at an application rate from about 7 g ae/ha to about 225 g ae/ha based on the total amount of active ingredients in the composition.

The components of the mixtures described herein can be applied either separately or as part of a multipart herbicidal system. In some embodiments of the methods described herein, the active ingredients are applied simultaneously, including, e.g., in the form of a composition. In some embodiments, the active ingredients are applied sequentially, e.g., within 5, 10, 15, or 30 minutes of each other; 1, 2, 3, 4, 5, 10, 12, 24, 48 hour(s) of each other, or 1 week of each other.

The mixtures described herein can be applied in conjunction with one or more other herbicides to control a wider variety of undesirable vegetation. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the compositions and methods described herein include, but are not limited to: 4-CPA, 4-CPB, 4-CPP, 2,4-D, 2,4-D choline salt, 2,4-D esters and amines, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlomitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclosulfamuron, cycloxydim, cycluron, cyhalofop-butyl, cyperquat, cyprazine, cyprazole, cypromid, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, ferrous sulfate, flamprop, flamprop-M, flazasulfuron, florasulam, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, fumiclorac, furyloxyfen, glufosinate, glufosinate-ammonium, glufosinate-P-ammonium, glyphosate, halosafen, halosulfuron-methyl, haloxydine, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxyfluorfen, paraflufen-ethyl, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thifensulfuron-methyl, thiobencarb, tiocarbazil, tioclorim, topramezone, tralkoxydim, triafamone, tri-allate, triasulfuron, triaziflam, tribenuron, tribenuron-methyl, tricamba, triclopyr choline salt, triclopyr esters and salts, tridiphane, trietazine, trifloxysulfuron, trifluralin, triflusulfuron, trifop, trifopsime, trihydroxytriazine, trimeturon, tripropindan, tritac tritosulfuron, vernolate, xylachlor and salts, esters, optically active isomers and mixtures thereof.

In some embodiments the methods provided herein are used to control undesirable vegetation in crops that are tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, or bromoxynil. Such herbicide-tolerant crops may possesses multiple or stacked traits conferring tolerance to multiple herbicides or multiple modes-of-action.

In some embodiments the methods provided herein are used to control undesirable vegetation that is a herbicide resistant or tolerant weed. Such herbicide resistant or tolerant weed may have a biotype with resistance or tolerance to multiple herbicides, multiple chemical classes, or multiple herbicide modes-of-action. For example, the herbicide resistant or tolerant weed may have a biotype resistant or tolerant to acetolactate synthase (ALS) inhibitors, photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall, or organoarsenicals.

In some embodiments, the compositions described herein are employed in combination with one or more herbicide safeners, such as AD-67 (MON 4660), benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, R29148, 1-[4-(N-(2-methoxybenzoyl)sulfamoyl)phenyl]-3-methylurea, N-(2-methoxybenzoyl)-4-[(methylaminocarbonyl)amino]benzenesulfonamide and N-phenyl-sulfonylbenzoic acid amides, to enhance their selectivity. In some embodiments, the safeners are employed in rice, cereal, corn, or maize settings. In some embodiments, the safener is cloquintocet or an ester or salt thereof. In certain embodiments, cloquintocet is utilized to antagonize harmful effects of the compositions on rice and cereals. In some embodiments, the safener is cloquintocet (mexyl).

In some embodiments, compositions provided herein further comprise at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions. They can also be provided as a pre-mix or tank-mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8E0); tallow amine ethoxylate (15 EO); PEG (400) dioleate-99.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

In some embodiments, the compositions described herein further comprise one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical Publishing Co., New York, 1980-81. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide additionproducts, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; poly-ethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include but are not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

In some embodiments, the concentration of the active ingredients in the compositions described herein is from about 0.0005 to 98 percent by weight. In some embodiments, the concentration is from about 0.0006 to 90 percent by weight. In compositions designed to be employed as concentrates, the active ingredients, in certain embodiments, are present in a concentration from about 0.1 to 98 weight percent, and in certain embodiments about 0.5 to 90 weight percent. Such compositions are, in certain embodiments, diluted with an inert carrier, such as water, before application. The diluted compositions usually applied to weeds or the locus of weeds contain, in certain embodiments, about 0.0005 to 15.0 weight percent active ingredient and in certain embodiments contain about 0.001 to 12.0 weight percent.

The present compositions can be applied to weeds or their locus by the use of conventional ground or aerial dusters, sprayers, and granule applicators, by addition to irrigation or paddy water, and by other conventional means known to those skilled in the art.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

Evaluation of Postemergent Herbicidal Activity. Seeds or nutlets of the desired test plant species were planted in Sun Gro Metro-Mix® 360 planting mixture, which typically has a pH of 6.0 to 6.8 and an organic matter content of about 30 percent, in plastic pots with a surface area of 64 square centimeters (cm²). When required to ensure good germination and healthy plants, a fungicide treatment and/or other chemical or physical treatment was applied. The plants were grown for 7-21 days (d) in a greenhouse with an approximate 15 hour (h) photoperiod which was maintained at about 23-29° C. during the day and 22-28° C. during the night. Nutrients and water were added on a regular basis and supplemental lighting was provided with overhead metal halide 1000-Watt lamps as necessary. The plants were employed for testing when they reached the first or second true leaf stage.

A weighed amount, determined by the highest rate to be tested, of each test compound was placed in a 25 milliliter (mL) glass vial and was dissolved in 4 mL of a 97:3 volume per volume (v/v) mixture of acetone and dimethyl sulfoxide (DMSO) to obtain concentrated stock solutions. If the test compound did not dissolve readily, the mixture was warmed and/or sonicated. The concentrated stock solutions obtained were diluted with 20 mL of an aqueous mixture containing acetone, water, isopropyl alcohol, DMSO, Atplus 411F crop oil concentrate, and Triton® X-155 surfactant in a 48.5:39:10:1.5:1.0:0.02 v/v ratio to obtain spray solutions containing the highest application rates. Additional application rates were obtained by serial dilution of 12 mL of the high rate solution into a solution containing 2 mL of a 97:3 v/v mixture of acetone and DMSO and 10 mL of an aqueous mixture containing acetone, water, isopropyl alcohol, DMSO, Atplus 411F crop oil concentrate, and Triton X-155 surfactant in a 48.5:39:10:1.5:1.0:0.02 v/v ratio to obtain ½X, ¼X, ⅛X and 1/16X rates of the high rate. Compound requirements are based upon a 12 mL application volume at a rate of 187 liters per hectare (L/ha). Formulated compounds were applied to the plant material with an overhead Mandel track sprayer equipped with 8002E nozzles calibrated to deliver 187 L/ha over an application area of 0.503 square meters (m²) at a spray height of 18 inches (43 cm) above the average plant canopy height. Control plants were sprayed in the same manner with the solvent blank.

Treatments consisted of the methyl ester of 4-amino-3-chloro-6-(4-chloro-2-fluoro-3-methoxyphenyl)pyridine-2-carboxylic acid (Cmpd 1) as technical grade material and fluazifop-P-butyl (Fusilade® DX), haloxyfop-P-methyl (GALLANT® super), and quizalofop-P-ethyl (Assure® II) alone and in combination. The form of compound of formula (I) and fluazifop-P-butyl, haloxyfop-P-methyl, and quizalofop-P-ethyl were applied on an acid equivalent basis.

The treated plants and control plants were placed in a greenhouse as described above and watered by subirrigation to prevent wash-off of the test compounds. After 14 d, the condition of the test plants as compared with that of the untreated plants was determined visually and scored on a scale of 0 to 100 percent where 0 corresponds to no injury and 100 corresponds to complete kill. Some of the compounds tested, application rates employed, plant species tested, and results are given in Tables 1-3.

Evaluation of Postemergence Foliar-Applied Herbicidal Mixtures for Control of Weeds Common to Row Crops such as Corn and Soybeans. Seeds or nutlets of the desired test plant species were planted in a soil matrix prepared by mixing a loam or sandy loam soil (e.g., 28.6 percent silt, 18.8 percent clay, and 52.6 percent sand, with a pH of about 5.8 and an organic matter content of about 1.8 percent) and calcareous grit in an 80 to 20 ratio. The soil matrix was contained in plastic pots with a surface area of 84.6 cm² and a volume of 560 cubic centimeters (cm³). When required to ensure good germination and healthy plants, a fungicide treatment and/or other chemical or physical treatment was applied. The plants were grown for 7-31 d in a greenhouse with an approximate 15 h photoperiod which was maintained at about 23-29° C. during the day and 22-28° C. during the night. Nutrients (Peters Excel® 15-5-15 5-Ca 2-Mg) and water were added on a regular basis and supplemental lighting was provided with overhead metal halide 1000-Watt lamps as necessary. The plants were employed for testing when they reached the first, second, or third true leaf stage.

Treatment requirements were calculated based upon the rates being tested, the concentration of active ingredient or acid equivalent in the formulation, and a 12 mL application volume at a rate of 187 L/ha.

Treatments consisted of the potassium (K⁺) salt of 4-amino-3-chloro-6-(4-chloro-2-fluoro-3-methoxyphenyl)-pyridine-2-carboxylic acid (Cmpd 4) formulated as a soluble liquid (SL), the propargyl ester of 4-amino-3-chloro-6-(4-chloro-2-fluoro-3-methoxyphenyl)-pyridine-2-carboxylic acid (Cmpd 2) as technical grade material, or the benzyl ester of 4-amino-3-chloro-6-(4-chloro-2-fluoro-3-methoxyphenyl)-pyridine-2-carboxylic acid (Cmpd 3) as technical grade material and quizalofop-p-ethyl (Assure® II) alone and in combination. Forms of compound of formula (I) and quizalofop-P-ethyl were applied on an acid equivalent basis.

For treatments comprised of formulated compounds, measured amounts of compounds were placed individually in 25 mL glass vials and diluted in a volume of 1.5% (v/v) Agri-Dex® crop oil concentrated to obtain 6× stock solutions. If a test compound did not dissolve readily, the mixture was warmed and/or sonicated. Application solutions were prepared by adding an appropriate amount of each stock solution (typically 2 mL) and diluted to the appropriate final concentrations with the addition of an appropriate amount of an aqueous mixture of 1.5% (v/v) crop oil concentrate and water so that the final spray solutions contained 1.25+/−0.05% (v/v) crop oil concentrate.

For treatments comprised of formulated and technical compounds, weighed amounts of the technical materials were placed individually in 25 mL glass vials and dissolved in a volume of 97:3 v/v acetone/DMSO to obtain 6× stock solutions, and measured amounts of the formulated compounds were placed individually in 25 mL glass vials and diluted in a volume of 1.5% (v/v) crop oil concentrate or water to obtain 6× stock solutions. If a test compound did not dissolve readily, the mixture was warmed and/or sonicated. Application solutions were prepared by adding an appropriate amount of each stock solution (e.g., 2 mL) and diluted to the appropriate final concentrations with the addition of an appropriate amount of an aqueous mixture of 1.5% (v/v) crop oil concentrate and water so that the final spray solutions contained 1.25% (v/v) crop oil concentrate. When required, additional water and/or 97:3 v/v acetone/DMSO can be added to individual application solutions so that the final acetone and DMSO concentrations of the application solutions being compared are 16.2% and 0.5%, respectively.

All stock solutions and applications solutions were visually inspected for compound compatibility prior to application. Compound requirements are based upon a 12 mL application volume at a rate of 187 liters per hectare (L/ha). Formulated compounds were applied to the plant material with an overhead Mandel track sprayer equipped with 8002E nozzles calibrated to deliver 187 L/ha over an application area of 0.503 square meters (m²) at a spray height of 20 inches (50 cm) above the average plant canopy height. Control plants were sprayed in the same manner with the solvent blank.

The treated plants and control plants were placed in a greenhouse as described above and watered by sub-irrigation to prevent wash-off of the test compounds. After approximately 2 weeks, the condition of the test plants as compared with that of the untreated plants was determined visually and scored on a scale of 0 to 100 percent where 0 corresponds to no injury or growth inhibition and 100 corresponds to complete kill. Some of the compounds tested, application rates employed, plant species tested, and results are given in Tables 4-12.

Results of testing mixtures in accordance with this disclosure and of the components of the mixtures separately against various common weeds in greenhouse trials are reported in the following tables. The reported values are of percent (%) control or percent (%) injury, visually rated. Colby's equation was used to determine the herbicidal effects expected from the mixtures (Colby, S. R. Calculation of the synergistic and antagonistic response of herbicide combinations. Weeds 1967, 15, 20-22.).

More specifically, the following equation was used to calculate the expected activity of mixtures containing two active ingredients, A and B:

Expected=A+B−(A×B/100)

A=observed efficacy of active ingredient A at the same concentration as used in the mixture;
B=observed efficacy of active ingredient B at the same concentration as used in the mixture.
The compounds tested, application rates employed, plant species tested, and results are given in Tables 1-12.
The following abbreviations are used in the following Tables:
ABUTH Abutilon theophrasti Medik. (velvetleaf)
AMARE Amaranthus retroflexus L. (redroot pigweed)
AVEFA Avena fatua L. (wild oat)
BRSNW Brassica napus (winter oilseed rape)
CHEAL Chenopodium album L. (common lambsquarters)
CIRAR Cirsium arvense (L.) Scop. (Canada thistle)
CYPES Cyperus esculentus L. (yellow nutsedge)
DIGSA Digitaria sanguinalis (L.) Scop. (large crabgrass)
EPHHL Euphorbia heterophylla L. (wild poinsettia)
GLXMA Glycine max (soybean)
HELAN Helianthus annuus L. (common sunflower)
IPOHE Ipomoea hederacea (L.) Jacq. (ivyleaf momingglory)
LOLMU Lolium multiflorum Lam. (Italian ryegrass)
OEOBI Oenothera biennis (evening primrose)
SETFA Setaria faberi Herrm. (giant foxtail)
SORHA Sorghum halepense (L.) Pers. (Johnsongrass)
SORVU Sorghum vulgare (common sorghum)
STEME Stellaria media (L.) Vill. (common chickweed)
VIOTR Viola tricolor L. (wild violet)
g ae/ha=grams acid equivalent per hectare
Obs=observed value of percent (%) control rated visually
Exp=expected value of percent (%) control as calculated by Colby's equation
DAA=days after application
Cmpd 1=methyl ester of the compound of formula (I)
Cmpd 2=propargyl ester of the compound of formula (I)
Cmpd 3=benzyl ester of the compound of formula (I)
Cmpd 4=potassium salt of the compound of formula (I)

TABLE 1a
Synergistic composition of Cmpd 1 and fluazifop-P-butyl

| Application Rate | | Visual Growth Reduction (%) 14 Days After Application (DAA) | | | | | | | | | | | | | | | |
|---|---|---|---|---|---|---|---|---|---|---|---|---|---|---|---|---|---|
| (g ae/ha) | | BRSNW | | CHEAL | | VIOTR | | STEME | | AVEFA | | DIGSA | | ABUTH | | CIRAR | |
| Cmpd 1 | Fluazifop-P | Obs | Exp | Obs | Exp | Obs | Exp | Obs | Exp | Obs | Exp | Obs | Exp | Obs | Exp | Obs | Exp |
| 1.25 | 0 | 0 | — | 70 | — | 10 | — | 30 | — | 0 | — | 0 | — | 80 | — | 30 | — |
| 2.5 | 0 | 5 | — | 80 | — | 10 | — | 20 | — | 0 | — | 0 | — | 85 | — | 50 | — |
| 5 | 0 | 20 | — | 93 | — | 30 | — | 40 | — | 0 | — | 0 | — | 90 | — | 30 | — |
| 0 | 52.5 | 0 | — | 0 | — | 0 | — | 0 | — | 0 | — | 70 | — | 0 | — | 0 | — |
| 0 | 105 | 0 | — | 0 | — | 0 | — | 0 | — | 0 | — | 80 | — | 0 | — | 0 | — |
| 0 | 210 | 0 | — | 0 | — | 0 | — | 0 | — | 70 | — | 85 | — | 0 | — | 0 | — |
| 1.25 | 52.5 | 0 | 0 | 93 | 70 | 30 | 10 | 20 | 30 | 0 | 0 | 90 | 70 | 87 | 80 | 40 | 30 |
| 1.25 | 105 | 10 | 0 | 97 | 70 | 40 | 10 | 20 | 30 | 40 | 0 | 90 | 80 | 90 | 80 | 50 | 30 |
| 1.25 | 210 | 10 | 0 | 95 | 70 | 30 | 10 | 20 | 30 | 95 | 70 | 93 | 85 | 80 | 80 | 50 | 30 |
| 2.5 | 52.5 | 10 | 5 | 95 | 80 | 50 | 10 | 40 | 20 | 10 | 0 | 80 | 70 | 95 | 85 | 40 | 50 |
| 2.5 | 105 | 30 | 5 | 97 | 80 | 60 | 10 | 40 | 20 | 50 | 0 | 90 | 80 | 95 | 85 | 50 | 50 |
| 2.5 | 210 | 25 | 5 | 97 | 80 | 65 | 10 | 40 | 20 | 85 | 70 | 93 | 85 | 97 | 85 | 50 | 50 |
| 5 | 52.5 | 40 | 20 | 97 | 93 | 70 | 30 | 65 | 40 | 0 | 0 | 90 | 70 | 98 | 90 | 50 | 30 |
| 5 | 105 | 40 | 20 | 97 | 93 | 60 | 30 | 60 | 40 | 10 | 0 | 90 | 80 | 97 | 90 | 40 | 30 |
| 5 | 210 | 60 | 20 | 97 | 93 | 65 | 30 | 60 | 40 | 93 | 70 | 93 | 85 | 90 | 90 | 30 | 30 |

TABLE 1b
Synergistic composition of Cmpd 1 and fluazifop-P-butyl

| Application Rate | | Visual Growth Reduction (%) 14 DAA | | | | | | | | | | | | | | | |
|---|---|---|---|---|---|---|---|---|---|---|---|---|---|---|---|---|---|
| (g ae/ha) | | SETFA | | SORVU | | AMARE | | EPHHL | | CYPES | | IPOHE | | GLXMA | | HELAN | |
| Cmpd 1 | Fluazifop-P | Obs | Exp | Obs | Exp | Obs | Exp | Obs | Exp | Obs | Exp | Obs | Exp | Obs | Exp | Obs | Exp |
| 1.25 | 0 | 0 | — | 0 | — | 50 | — | 95 | — | 50 | — | 10 | — | 70 | — | 20 | — |
| 2.5 | 0 | 0 | — | 0 | — | 60 | — | 95 | — | 90 | — | 20 | — | 95 | — | 20 | — |
| 5 | 0 | 30 | — | 0 | — | 90 | — | 95 | — | 93 | — | 20 | — | 97 | — | 40 | — |
| 0 | 52.5 | 80 | — | 70 | — | 0 | — | 0 | — | 0 | — | 0 | — | 0 | — | 0 | — |
| 0 | 105 | 80 | — | 90 | — | 0 | — | 0 | — | 0 | — | 0 | — | 0 | — | 0 | — |
| 0 | 210 | 90 | — | 100 | — | 0 | — | 0 | — | 0 | — | 0 | — | 0 | — | 0 | — |
| 1.25 | 52.5 | 85 | 80 | 85 | 70 | 80 | 50 | 90 | 95 | 80 | 50 | 20 | 10 | 97 | 70 | 20 | 20 |
| 1.25 | 105 | 93 | 80 | 100 | 90 | 90 | 50 | 97 | 95 | 70 | 50 | 20 | 10 | 95 | 70 | 25 | 20 |
| 1.25 | 210 | 95 | 90 | 100 | 100 | 60 | 50 | 97 | 95 | 90 | 50 | 20 | 10 | 97 | 70 | 20 | 20 |
| 2.5 | 52.5 | 90 | 80 | 90 | 70 | 95 | 60 | 95 | 95 | 85 | 90 | 20 | 20 | 95 | 95 | 20 | 20 |
| 2.5 | 105 | 95 | 80 | 100 | 90 | 97 | 60 | 97 | 95 | 90 | 90 | 30 | 20 | 100 | 95 | 30 | 20 |
| 2.5 | 210 | 100 | 90 | 100 | 100 | 100 | 60 | 97 | 95 | 95 | 90 | 30 | 20 | 100 | 95 | 20 | 20 |
| 5 | 52.5 | 80 | 86 | 80 | 70 | 90 | 90 | 97 | 95 | 97 | 93 | 40 | 20 | 100 | 97 | 60 | 40 |
| 5 | 105 | 85 | 86 | 100 | 90 | 97 | 90 | 97 | 95 | 97 | 93 | 40 | 20 | 100 | 97 | 65 | 40 |
| 5 | 210 | 100 | 93 | 100 | 100 | 95 | 90 | 97 | 95 | 97 | 93 | 30 | 20 | 100 | 97 | 40 | 40 |

TABLE 2
Synergistic composition of Cmpd 1 and haloxyfop-P-methyl

| Application Rate | | Visual Growth Reduction (%) 14 DAA | | | | | | | | | | | | | |
|---|---|---|---|---|---|---|---|---|---|---|---|---|---|---|---|
| (g ae/ha) | | BRSNW | | CHEAL | | VIOTR | | STEME | | AMARE | | CYPES | | IPOHE | |
| Cmpd 1 | Haloxyfop-P | Obs | Exp | Obs | Exp | Obs | Exp | Obs | Exp | Obs | Exp | Obs | Exp | Obs | Exp |
| 1.25 | 0 | 0 | — | 70 | — | 10 | — | 30 | — | 50 | — | 50 | — | 10 | — |
| 2.5 | 0 | 5 | — | 80 | — | 10 | — | 20 | — | 60 | — | 90 | — | 20 | — |
| 5 | 0 | 20 | — | 93 | — | 30 | — | 40 | — | 90 | — | 93 | — | 20 | — |
| 0 | 35 | 0 | — | 0 | — | 0 | — | 0 | — | 0 | — | 0 | — | 0 | — |
| 0 | 70 | 0 | — | 0 | — | 0 | — | 0 | — | 0 | — | 0 | — | 0 | — |
| 0 | 140 | 0 | — | 0 | — | 0 | — | 0 | — | 0 | — | 0 | — | 0 | — |
| 1.25 | 35 | 0 | 0 | 85 | 70 | 20 | 10 | 10 | 30 | 85 | 50 | 70 | 50 | 20 | 10 |
| 1.25 | 70 | 10 | 0 | 87 | 70 | 30 | 10 | 15 | 30 | 70 | 50 | 60 | 50 | 30 | 10 |
| 1.25 | 140 | 20 | 0 | 90 | 70 | 40 | 10 | 15 | 30 | 80 | 50 | 70 | 50 | 30 | 10 |
| 2.5 | 35 | 30 | 5 | 95 | 80 | 55 | 10 | 60 | 20 | 95 | 60 | 93 | 90 | 20 | 20 |
| 2.5 | 70 | 30 | 5 | 90 | 80 | 30 | 10 | 40 | 20 | 95 | 60 | 95 | 90 | 30 | 20 |
| 2.5 | 140 | 10 | 5 | 90 | 80 | 30 | 10 | 30 | 20 | 95 | 60 | 95 | 90 | 25 | 20 |
| 5 | 35 | 30 | 20 | 85 | 93 | 70 | 30 | 70 | 40 | 97 | 90 | 97 | 93 | 20 | 20 |
| 5 | 70 | 25 | 20 | 87 | 93 | 50 | 30 | 65 | 40 | 100 | 90 | 97 | 93 | 30 | 20 |
| 5 | 140 | 30 | 20 | 93 | 93 | 60 | 30 | 60 | 40 | 100 | 90 | 97 | 93 | 40 | 20 |

TABLE 3
Synergistic composition of Cmpd 1 and quizalofop-P-ethyl

| Application Rate | | Visual Growth Reduction (%) 14 DAA | | | | | | | | | | | | | |
|---|---|---|---|---|---|---|---|---|---|---|---|---|---|---|---|
| (g ae/ha) | | BRSNW | | CHEAL | | VIOTR | | STEME | | CIRAR | | AMARE | | IPOHE | |
| Cmpd 1 | Quizalofop-P | Obs | Exp | Obs | Exp | Obs | Exp | Obs | Exp | Obs | Exp | Obs | Exp | Obs | Exp |
| 1.25 | 0 | 0 | — | 70 | — | 10 | — | 30 | — | 30 | — | 50 | — | 10 | — |
| 2.5 | 0 | 5 | — | 80 | — | 10 | — | 20 | — | 30 | — | 60 | — | 20 | — |
| 5 | 0 | 20 | — | 93 | — | 30 | — | 40 | — | 30 | — | 90 | — | 20 | — |
| 0 | 37.5 | 0 | — | 0 | — | 0 | — | 0 | — | 0 | — | 0 | — | 0 | — |
| 0 | 75 | 0 | — | 0 | — | 0 | — | 0 | — | 0 | — | 0 | — | 0 | — |
| 0 | 150 | 0 | — | 0 | — | 0 | — | 0 | — | 0 | — | 0 | — | 0 | — |
| 1.25 | 37.5 | 0 | 0 | 95 | 70 | 10 | 10 | 20 | 30 | 30 | 30 | 93 | 50 | 20 | 10 |
| 1.25 | 75 | 10 | 0 | 95 | 70 | 40 | 10 | 30 | 30 | 40 | 30 | 85 | 50 | 30 | 10 |
| 1.25 | 150 | 10 | 0 | 95 | 70 | 50 | 10 | 30 | 30 | 50 | 30 | 97 | 50 | 30 | 10 |
| 2.5 | 37.5 | 20 | 5 | 90 | 80 | 10 | 10 | 30 | 20 | 30 | 30 | 97 | 60 | 10 | 20 |
| 2.5 | 75 | 20 | 5 | 93 | 80 | 50 | 10 | 40 | 20 | 40 | 30 | 100 | 60 | 30 | 20 |
| 2.5 | 150 | 20 | 5 | 97 | 80 | 50 | 10 | 40 | 20 | 40 | 30 | 100 | 60 | 30 | 20 |
| 5 | 37.5 | 20 | 20 | 97 | 93 | 30 | 30 | 65 | 40 | 40 | 30 | 97 | 90 | 30 | 20 |
| 5 | 75 | 30 | 20 | 97 | 93 | 40 | 30 | 65 | 40 | 40 | 30 | 100 | 90 | 30 | 20 |
| 5 | 150 | 30 | 20 | 100 | 93 | 50 | 30 | 50 | 40 | 50 | 30 | 100 | 90 | 30 | 20 |

TABLE 4
Synergistic control of OEOBI with combination
of Cmpd 2 and quizalofop-P-ethyl

| Treatment | | Percent (%) injury rated visually | |
|---|---|---|---|
| (g ae/ha) | | 14 days after application (DAA) | |
| Cmpd 2 | Quizalofop-P-ethyl | Obs | Exp |
| 3.75 | 0 | 65 | |
| 0 | 7.125 | 0 | |
| 0 | 14.25 | 0 | |
| 0 | 28.5 | 0 | |
| 3.75 | 7.125 | 75 | 65 |
| 3.75 | 14.25 | 75 | 65 |
| 3.75 | 28.5 | 85 | 65 |

TABLE 5
Synergistic control of SORHA with combination
of Cmpd 2 and quizalofop-P-ethyl

| Treatment | | Percent (%) injury rated visually | |
|---|---|---|---|
| (g ae/ha) | | 14 DAA | |
| Cmpd 2 | Quizalofop-P-ethyl | Obs | Exp |
| 3.75 | 0 | 0 | |
| 7.5 | 0 | 0 | |
| 15 | 0 | 10 | |
| 0 | 7.125 | 50 | |
| 3.75 | 7.125 | 100 | 50 |
| 7.5 | 7.125 | 100 | 50 |
| 15 | 7.125 | 99 | 55 |

TABLE 6
Synergistic control of AVEFA with combination
of Cmpd 3 and quizalofop-P-ethyl

| Treatment | | Percent (%) injury rated visually | |
|---|---|---|---|
| (g ae/ha) | | 14 DAA | |
| Cmpd 3 | Quizalofop-P-ethyl | Obs | Exp |
| 3.75 | 0 | 10 | |
| 7.5 | 0 | 0 | |
| 15 | 0 | 0 | |
| 0 | 3.56 | 15 | |
| 0 | 7.125 | 15 | |
| 0 | 14.25 | 40 | |
| 3.75 | 3.56 | 40 | 24 |
| 7.5 | 3.56 | 20 | 15 |
| 15 | 3.56 | 50 | 15 |
| 3.75 | 7.125 | 40 | 24 |
| 7.5 | 7.125 | 40 | 15 |
| 15 | 7.125 | 15 | 15 |
| 3.75 | 14.25 | 75 | 46 |
| 7.5 | 14.25 | 80 | 40 |
| 15 | 14.25 | 60 | 40 |

TABLE 7
Synergistic control of DIGSA with combination
of Cmpd 3 and quizalofop-P-ethyl

| Treatment | | Percent (%) injury rated visually | |
|---|---|---|---|
| (g ae/ha) | | 14 DAA | |
| Cmpd 3 | Quizalofop-P-ethyl | Obs | Exp |
| 3.75 | 0 | 40 | |
| 7.5 | 0 | 40 | |
| 15 | 0 | 35 | |
| 0 | 3.56 | 20 | |
| 3.75 | 3.56 | 70 | 52 |
| 7.5 | 3.56 | 85 | 52 |
| 15 | 3.56 | 70 | 48 |

TABLE 8
Synergistic control of LOLMU with combination
of Cmpd 3 and quizalofop-P-ethyl

| Treatment | | Percent (%) injury rated visually | |
|---|---|---|---|
| (g ae/ha) | | 14 DAA | |
| Cmpd 3 | Quizalofop-P-ethyl | Obs | Exp |
| 3.75 | 0 | 15 | |
| 7.5 | 0 | 50 | |
| 15 | 0 | 40 | |
| 0 | 3.56 | 0 | |
| 3.75 | 3.56 | 25 | 15 |
| 7.5 | 3.56 | 60 | 50 |
| 15 | 3.56 | 65 | 40 |

TABLE 9
Synergistic control of DIGSA with combination
of Cmpd 4 and quizalofop-P-ethyl

| Treatment | | Percent (%) injury rated visually | |
|---|---|---|---|
| (g ae/ha) | | 14 DAA | |
| Cmpd 4 | Quizalofop-P-ethyl | Obs | Exp |
| 3.75 | 0 | 20 | |
| 7.5 | 0 | 15 | |
| 15 | 0 | 40 | |
| 0 | 3.56 | 20 | |
| 3.75 | 3.56 | 50 | 36 |
| 7.5 | 3.56 | 50 | 32 |
| 15 | 3.56 | 50 | 52 |

TABLE 10
Synergistic control of LOLMU with combination
of Cmpd 4 and quizalofop-P-ethyl

| Treatment | | Percent (%) injury rated visually | |
|---|---|---|---|
| (g ae/ha) | | 14 DAA | |
| Cmpd 4 | Quizalofop-P-ethyl | Obs | Exp |
| 3.75 | 0 | 0 | |
| 7.5 | 0 | 15 | |
| 15 | 0 | 40 | |
| 0 | 3.56 | 0 | |
| 3.75 | 3.56 | 15 | 0 |
| 7.5 | 3.56 | 50 | 15 |
| 15 | 3.56 | 50 | 40 |

TABLE 11
Synergistic control of SORHA with combination
of Cmpd 4 and quizalofop-P-ethyl

| Treatment | | Percent (%) injury rated visually | |
|---|---|---|---|
| (g ae/ha) | | 14 DAA | |
| Cmpd 4 | Quizalofop-P-ethyl | Obs | Exp |
| 3.75 | 0 | 0 | |
| 7.5 | 0 | 0 | |
| 15 | 0 | 10 | |
| 0 | 7.125 | 50 | |
| 3.75 | 7.125 | 99 | 50 |
| 7.5 | 7.125 | 95 | 50 |
| 15 | 7.125 | 95 | 55 |

TABLE 12
Synergistic control of OEOBI with combination
of Cmpd 4 and quizalofop-P-ethyl

| Treatment | | Percent (%) injury rated visually | |
|---|---|---|---|
| (g ae/ha) | | 14 DAA | |
| Cmpd 4 | Quizalofop-P-ethyl | Obs | Exp |
| 3.75 | 0 | 50 | |
| 7.5 | 0 | 80 | |
| 0 | 7.125 | 0 | |
| 0 | 14.25 | 0 | |
| 0 | 28.5 | 0 | |
| 3.75 | 7.125 | 80 | 50 |
| 7.5 | 7.125 | 100 | 80 |
| 3.75 | 14.25 | 75 | 50 |
| 7.5 | 14.25 | 90 | 80 |
| 3.75 | 28.5 | 80 | 50 |
| 7.5 | 28.5 | 90 | 80 |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. An herbicidal composition comprising a herbicidally effective amount of a combination of (a) a compound of formula (I) 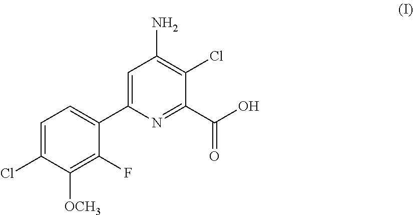 [SMILES: COc1c(Cl)ccc(-c2cc(N)c(Cl)c(C(=O)O)n2)c1F]
or an agriculturally acceptable salt or ester thereof and (b) an aryloxyphenoxy propionate ACCase inhibitor herbicide selected from the group consisting of fluazifop-P, haloxyfop-P, and quizalofop-P or an agriculturally acceptable salt or ester thereof.

2. The composition of claim 1, wherein the composition does not contain glufosinate or its salts, L-glufosinate or its salts, or bialaphos or its salts.

3. The composition of claim 1, wherein (a) is the methyl ester, benzyl ester, propargyl ester, or potassium salt of the compound of formula (I).

4. The composition of claim 1, further comprising a herbicide safener.

5. The composition of claim 1, wherein (b) is fluazifop-P or an agriculturally acceptable salt or ester thereof and the weight ratio of (a) to (b) is from about 1-40 of (a) to about 35-560 of (b).

6. The composition of claim 1, wherein (b) is fluazifop-P or an agriculturally acceptable salt or ester thereof and the weight ratio of (a) to (b) is from about 1-40 of (a) to about 70-210 of (b).

7. The composition of claim 1, wherein (b) is fluazifop-P or an agriculturally acceptable salt or ester thereof and the weight ratio of (a) to (b) is from about 1.25-5 of (a) to about 70-210 of (b).

8. The composition of claim 1, wherein (b) is haloxyfop-P or an agriculturally acceptable salt or ester thereof and the weight ratio of (a) to (b) is from about 1-40 of (a) to about 20-560 of (b).

9. The composition of claim 1, wherein (b) is haloxyfop-P or an agriculturally acceptable salt or ester thereof and the weight ratio of (a) to (b) is from about 1-40 of (a) to about 35-150 of (b).

10. The composition of claim 1, wherein (b) is haloxyfop-P or an agriculturally acceptable salt or ester thereof and the weight ratio of (a) to (b) is from about 1.25-5 of (a) to about 35-150 of (b).

11. The composition of claim 1, wherein (b) is quizalofop-P or an agriculturally acceptable salt or ester thereof and the weight ratio of (a) to (b) is from about 1-40 of (a) to about 3.5-560 of (b).

12. The composition of claim 1, wherein (b) is quizalofop-P or an agriculturally acceptable salt or ester thereof and the weight ratio of (a) to (b) is from about 1-40 of (a) to about 3.5-150 of (b).

13. The composition of claim 1, wherein (b) is quizalofop-P or an agriculturally acceptable salt or ester thereof and the weight ratio of (a) to (b) is from about 1.25-15 of (a) to about 3.5-150 of (b).

14. The composition of claim 1, wherein the composition is synergistic in control of BRSNW, CHEAL, VIOTR, STEME, AVEFA, DIGSA, ABUTH, CIRAR, SETFA, SORVU, AMARE, EPHHL, CYPES, IPOHE, GLXMA, HELAN, OEOBI, LOLMU, or SORHA as determined by the Colby equation.

15. A method of controlling undesirable vegetation which comprises applying the composition of claim 1.

16. A method of controlling undesirable vegetation which comprises applying a herbicidally effective amount of:
(a) a compound of the formula (I) 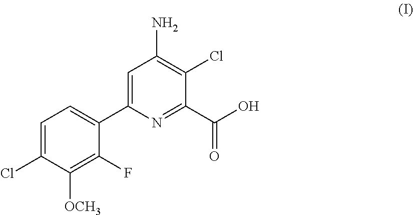 [SMILES: COc1c(Cl)ccc(-c2cc(N)c(Cl)c(C(=O)O)n2)c1F]
or an agriculturally acceptable salt or ester thereof and
(b) an aryloxyphenoxy propionate ACCase inhibitor herbicide selected from the group consisting of fluazifop-P, haloxyfop-P, and quizalofop-P or an agriculturally acceptable salt or ester thereof.

17. The method of claim 16, wherein no glufosinate or its salts, L-glufosinate or its salts, or bialaphos or its salts is also applied.

18. The method of claim 16, wherein the undesirable vegetation is controlled in winter/spring oilseed rape, winter/spring canola, vegetables, Brassica spp, ornamentals, rice, wheat, triticale, barley, oats, rye, sorghum, corn/maize, sunflower, row crops, pastures, grasslands, rangelands, fallowland, sugarcane, turf, tree and vine orchards, aquatics, and industrial vegetation management (IVM) and rights-of-way.

19. The method of claim 16, wherein (a) is the methyl ester of the compound of formula (I), (b) is fluazifop-P or an agriculturally acceptable salt or ester thereof, (a) is applied at a rate of 1-40 g ae/ha, and (b) is applied at a rate of 35-560 g ae/ha.

20. The method of claim 16, wherein (a) is the methyl ester of the compound of formula (I), (b) is fluazifop-P or an agriculturally acceptable salt or ester thereof, (a) is applied at a rate of 1.25-5 g ae/ha, and (b) is applied at a rate of 70-210 g ae/ha.

21. The method of claim 16, wherein (a) is the methyl ester of the compound of formula (I), (b) is haloxyfop-P or an agriculturally acceptable salt or ester thereof, (a) is applied at a rate of 1-40 g ae/ha, and (b) is applied at a rate of 20-560 g ae/ha.

22. The method of claim 16, wherein (a) is the methyl ester of the compound of formula (I), (b) is haloxyfop-P or an agriculturally acceptable salt or ester thereof, (a) is applied at a rate of 1.25-5 g ae/ha, and (b) is applied at a rate of 35-150 g ae/ha.

23. The method of claim 16, wherein (a) is the methyl ester, benzyl ester, propargyl ester, or potassium salt of the compound of formula (I), (b) is quizalofop-P or an agriculturally acceptable salt or ester thereof, (a) is applied at a rate of 1-40 g ae/ha, and (b) is applied at a rate of 3.5-560 g ae/ha.

24. The method of claim 16, wherein (a) is the methyl ester, benzyl ester, propargyl ester, or potassium salt of the compound of formula (I), (b) is quizalofop-P or an agriculturally acceptable salt or ester thereof, (a) is applied at a rate of 1.25-15 g ae/ha, and (b) is applied at a rate of 3.5-150 g ae/ha.

25. The method of claim 16, wherein the undesirable vegetation is immature.

26. The method claim 16, wherein the (a) and (b) are applied pre-emergently.

27. The method of claim 16, wherein the (a) and (b) are applied post-emergently.

28. The method of claim 16, wherein the undesirable vegetation is BRSNW, CHEAL, VIOTR, STEME, AVEFA, DIGSA, ABUTH, CIRAR, SETFA, SORVU, AMARE, EPHHL, CYPES, IPOHE, GLXMA, HELAN, OEOBI, LOLMU, or SORHA.

29. The method of any claim 16, wherein the undesirable vegetation is controlled in a crop that is tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, or bromoxynil.

30. The method of claim 29, wherein the tolerant crop possesses multiple or stacked traits conferring tolerance to multiple herbicides or multiple modes-of-action.

31. The method of claim 30, wherein the undesirable vegetation comprises a herbicide resistant or tolerant weed.

32. The method of claim 31, wherein the resistant or tolerant weed is a biotype with resistance or tolerance to multiple herbicides, multiple chemical classes, or multiple herbicide modes-of-action.

33. The method of claim 31, wherein the resistant or tolerant weed is a biotype resistant or tolerant to acetolactate synthase (ALS) inhibitors, photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall, or organoarsenicals.

34. The composition of claim 1, wherein (b) is fluazifop-P or an agriculturally acceptable salt or ester thereof, and the weight ratio of (a) to (b) is from 1:560 to 1:1.

35. The composition of claim 1, wherein (b) is fluazifop-P or an agriculturally acceptable salt or ester thereof, and the weight ratio of (a) to (b) is from 1:170 to 1:10.

36. The composition of claim 1, wherein (b) is haloxyfop-P or an agriculturally acceptable salt or ester thereof, and the weight ratio of (a) to (b) is from 1:560 to 1:1.

37. The composition of claim 1, wherein (b) is haloxyfop-P or an agriculturally acceptable salt or ester thereof, and the weight ratio of (a) to (b) is from 1:120 to 1:7.

38. The composition of claim 1, wherein (b) is quizalofop-P or an agriculturally acceptable salt or ester thereof, and the weight ratio of (a) to (b) is from 1:560 to 11.2:1.

39. The composition of claim 1, wherein (b) is quizalofop-P or an agriculturally acceptable salt or ester thereof, and the weight ratio of (a) to (b) is from 1:120 to 4.2:1.
